(19) United States
(12) Patent Application Publication
(10) Pub. No.: US 2003/0214578 A1
(43) Pub. Date: Nov. 20, 2003

(54) Image monitoring system

(76) Inventors: Carsten Luehwink, Hamburg (DE); Thorsten Ohmacht, Hannover (DE); Michael Meyer, Sibbesse (DE); Christof Ridder, Starnberg (DE); Juergen Koehler, Sarstedt (DE)

Correspondence Address: STRIKER, STRIKER & STENBY, 103 East Neck Road, Huntington, NY, 11743, US

(21) Appl. No.: 10/359,408

(22) Filed: Feb. 6, 2003

(30) Foreign Application Priority Data
May 18, 2002 (DE) 102 22 203.7

(51) Int. Cl. H04N 9/47; G09G 5/00

(52) U.S. Cl. 348/61; 345/716

(57) ABSTRACT

An image monitoring system has at least one image transducer, at least one evaluating unit with which the image transducer is connectable, an indicator for outputting a signal of the at least one image transducer and a user surface connectable with the evaluating unit, a manually movable input means for indication and for parametrization of the image monitoring system, connected to the evaluating unit, the indicator presenting a representive symbol for the input means.

### BACKGROUND OF THE INVENTION

The present invention relates to image monitoring systems.

Image monitoring systems are generally known in the art. It is believed that the existing image monitoring systems can be further improved.

### SUMMARY OF THE INVENTION

Accordingly, it is an object of the present invention to provide an image monitoring system which is a further improvement of the existing image monitoring systems.

In keeping with these objects and with others which will become apparent hereinafter, one feature of the present invention resides, briefly stated, in an image monitoring system which has at least one image transducer; at least one evaluating unit with which said image transducer is connectable; an indicator for outputting a signal of said at least one image transducer and a user surface connectable with said evaluating unit; a manually movable input means for indication and for parametrization of the image monitoring system, connected to said evaluating unit, said indicator presenting a representive symbol for said input means.

When the image monitoring system is designed in accordance with the present invention, it has the advantage that due to the manually movable input means drawings can be prepared directly and simply on the indicator, for example, graphically defining a monitoring scene. Lines and services can be directly identified. Furthermore, this input means which is provided for parameterizing of the image monitoring system allows that the drawing or the line and surface elements are then activated and subsequently can be changed freely in their position on the image screen. Thereby the operation is possible and particular only with one hand. With the user surface it is further possible to select directly menu points, for example by indicating to the corresponding image region, without a sequential passage of a list.

In accordance with another feature of the present invention, it is especially advantageous when the input means is formed as a computer mouse, so that a user who is familiar with such a computer mouse already from PC can perform the above mentioned actions in the image monitoring system.

By mixing of content-sensitive aide which is indicated in dependence on, for example a mouse pointer, a user is guided and supported in a simple manner.

Finally, in accordance with a further feature of the present invention it is advantageous when the user surface has a minute structure which can be passed by the input means by a navigation in a simple manner.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a block diagram of an inventive image monitoring system; and

FIG. 2 is an exemplary scene on an indicator of the inventive image monitoring system.

### DESCRIPTION OF THE PREFERRED EMBODIMENTS

An image monitoring system has evaluating units, in which an analog video signal of a connected video camera is analyzed and evaluated. In addition to video signals, also signals a thermal image or of an infrared camera or also of ultrasound image transducers can be evaluated as well. These devices must be parameterized. In other words, it must be defined what must be monitored and in dependence of which technical parameters it is to be performed.

In accordance with the present invention an input means is provided which is movable manually and therefore makes possible a direct drawing. This is of great use in particular for definition of a monitoring seam. This facilitates and accelerates parametrizing of the image monitoring system. This input means, for example a computer mouse, has to be used only for the duration of the parametrizing. Then it can be withdrawn, and normal monitoring can begin. This graphic operation device as the input means can reproduce a position change horizontally and vertically by a displacement on a straight background. Furthermore, two keys or rolls can reproduce different pulses.

The input means is connected with the evaluating unit of the image monitoring system either through a conductor or through an optical connection or through a radio connection. In addition to the monitoring scene, a user surface can be represented on the indicator. The position of the input means is represented by a symbol, for example a mouse pointer. The type of the mouse pointer to be shown changes with the position on the indicator and the performing action. If the mouse pointer stands on a predetermined point and can perform a predetermined action in the user guide, then a corresponding auxiliary text is outputted. This facilitates the user guidance. For navigation in the main structure, corresponding navigation elements as pictograms are provided which can be indicated directly with the mouse pointer and which can be activated by pressing the keys. Also other conventionally used input means can be utilized such as rolls.

Graphic elements such as lines and surfaces are directly indicated by moving the input means. The indicating elements are changeable with respect to their position and dimension. For this purpose the mouse indicator is to be positioned over the graphic element or a line of the graphic elements. If the mouse key remains pressed for example during the position change, a corresponding change is carried out on the shown element. This operation can be performed because of the construction of the input means, for example the mouse, with one hand. With the use of more than one key on the input means, graphic elements can be inputted with a different meaning, so that the addition and removal is possible.

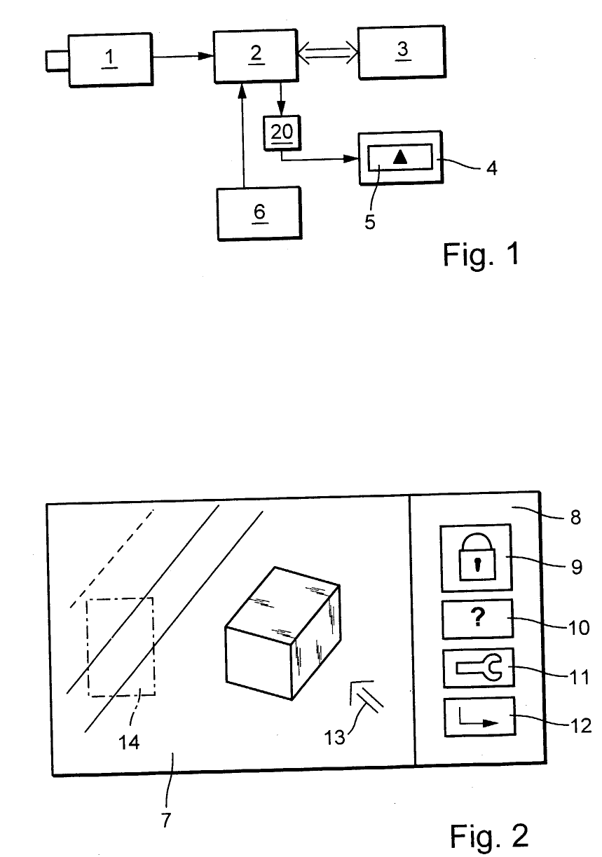

FIG. 1 shows a block diagram of the image monitoring system. A camera 1 is connected as an image transducer to a data input of an evaluating unit 2, here a processor. The processor 2 is connected with a memory 3 through a data input/output. The processor 2 is also connected with a computer mouse 6 through a second data input. The processor 2 is connected with an indicator 4 which has an indication field 5, through a data output.

The video camera 1 has a single processing which transmits a signal to the processor 2 in digital form. The analog video signal is converted by an analog-digital convertor and in a digital signal. It is possible alternatively that an analog video signal is transmitted by the camera 1 to the evaluating unit 2, which then carries out the digitalization itself. It is also possible to use a digital camera. Instead of a camera, several cameras can be connected to the evaluating unit 2. Alternatively to the video camera as an image transducer thermal image cameras, infrared sensors or ultrasound sensors can be used as well.

The memory 3 serves for charging an operational system and the user surface as well as for intermediate storage of data. The processor 2 controls the analog indicator 4 through a digital-analog convertor 20 directly, wherein the indicator 4 for this purpose has a signal processing. Alternatively, a computer monitor can be utilized. With the analog indicator 4 it is however advantageous that an analog image screen, which is already utilized, provides with the inventive image monitoring system to a simple operational service.

The computer mouse 6 is connected directly to the evaluating unit 2, and the evaluating unit 2 in the memory 3 has a driver for this computer mouse. The computer mouse 6 for this purpose has its own electronic system which converts the movements in horizontal and vertical directions into an electrical signal, to transmit these electrical signals then digitally to the processor 2.

Instead of a computer mouse 6, other input means can be used as well, which make possible a movement in a horizontal or vertical directions, so that such movements are suitable for indication on the indicator 4. With further different operation elements which are located on the input means 6, such as keys and rolls, activations or selections or a scrolling is possible in a simple manner. Advantageously after the adjustments which are performed by the input means 6 and the definition of the monitoring scenes or the parametrization of the inventive image monitoring system, the input means 6 is withdrawn so that a new adjustment by unauthorized persons is avoided.

This can be further complemented by software safety features which, in the event when a computer mouse is connected by a third person with the evaluating unit 10, does not allow the computer mouse to perform inputting. For this purpose after finalizing the parametrization by the input means 6, a securing is performed with the software. This securing can be removed for example by inputting of a code or by time-dependent securing which allows an input at predetermined times. Also, biometric securing features are possible, such as for example a finger print recognition, a retinal image recognition or speech recognition in combination or in addition.

FIG. 2 shows an example which is illustrated on the indication field 5. The observation scene is represented in the left region 7 on the indication field 5. It shows a street and a building. The rectangle 14 defines the later monitored scene. In other words, only that scene which is located in the field 14 is then actually monitored by the system. The user guide is located at the right side 8 of the indication field 5. Here by representation of pictograms, a selection of functions is possible. By clicking the field 9 in which a mouse pointer 3 is positioned on the field 9, a securing of the adjustment is carried out. In other words, the computer mouse 6 can be withdrawn, and after the connection of another computer mouse the adjustments can no longer be changed. Then an authorization of the monitoring system is made possible. This can be performed by inputting of a code number which is defined for access authorization.

By the positioning on the field 14, informations can be inquired, for example a status or a tutoring. By activation of the field 11 an exchange for a further image screen is possible, in which the indication of the field 14 is performed by activation of field 12 jumping is performed to another new point with new selection functions. This further image screen can be designed for example textually. Therefore clarifications or representations can be provided. For example, which symbols are indicated for representing a loading, a precision selection, a deficient availability, a vertical dimension change, a horizontal or diagonal dimension change and a displacement. Further representation possibilities are adjustable. It is important however that the definition is possible by the indication of the monitoring scene with the computer mouse 6.

It will be understood that each of the elements described above, or two or more together, may also find a useful application in other types of constructions differing from the types described above.

While the invention has been illustrated and described as embodied in image monitoring system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An image monitoring system, comprising at least one image transducer; at least one evaluating unit with which said image transducer is connectable; an indicator for outputting a signal of said at least one image transducer and a user surface connectable with said evaluating unit; a manually movable input means for indication and for parametrization of the image monitoring system, connected to said evaluating unit, said indicator presenting a representive symbol for said input means.

2. An image monitoring system as defined in claim 1, wherein said input means is formed as a computer mouse.

3. An image monitoring system as defined in claim 1, wherein said evaluating unit has a memory, from which a context-sensitive aid for outputting from said indicator, depending on a position of the symbol, is chargeable.

4. An image monitoring system as defined in claim 2, wherein said evaluating unit has a memory, from which a context-sensitive aid for outputting from said indicator, depending on a position of the symbol, is chargeable.

5. An image monitoring system as defined in claim 1, wherein said user surface has a menul structure, with which a navigation of said input means is possible.
